(19) United States
(12) Patent Application Publication
(10) Pub. No.: US 2026/0128530 A1
(43) Pub. Date: May 7, 2026

(54) CIRCULARLY POLARIZED ANTENNA AND COMMUNICATION SYSTEM

(71) Applicant: Nanning FuLian FuGui Precision Industrial Co., Ltd., Nanning (CN)

(72) Inventors: YI-MING CHEN, Hsinchu (TW); SHENG-MIN LIN, Hsinchu (TW); SZU-TI CHEN, Hsinchu (TW)

(21) Appl. No.: 18/938,480

(22) Filed: Nov. 6, 2024

(51) Int. Cl. H01Q 19/00; H01Q 1/28; H01Q 13/10; H01Q 19/02

(52) U.S. Cl. CPC H01Q 19/005; H01Q 13/106; H01Q 19/025; H01Q 1/288

(57) ABSTRACT

A circularly polarized antenna includes an antenna unit and a feeding unit, and the antenna unit and the feeding unit are stacked up and down; the antenna unit includes a first antenna subunit arranged on a top layer of the first substrate, a parasitic element arranged in a middle layer of the first substrate, and a second antenna subunit arranged on a bottom layer of the first substrate; the feeding unit includes a coupling slot group, arranged on a top layer of the second substrate; a matching microstrip line group, arranged on a middle layer of the second substrate; a feeding line group, arranged on a bottom layer of the second substrate; a branch line coupler, arranged on a bottom layer of the second substrate, wherein the matching microstrip line group is electrically connected between the feeding line group and the branch line coupler through a hole group.

### FIELD

The present disclosure generally relates to a technical field of antenna, and more particularly to a circularly polarized antenna and a communication system.

### BACKGROUND

In recent years, the technology of phase array antenna, such as low-orbit satellite communication system and radar system, has transitioned from military use to general use. So the traditional phase array antenna technology has changed from a flat T/R module to a highly integrated vertically integrated T/R module, which is conducive to reducing the size, the area and the weight of communication systems. Therefore, matching the structure and the impedance matching between the integrated tile-type antenna and T/R module is becoming the focus of designing an antenna array. The antenna polarization is also changed from linear polarization to circular polarization, mainly because the circularly polarized antennas do not require alignment with the direction of radio wave polarization, and the circularly polarized antennas can transmit and receive signals in different angles and environment, which can effectively reduce the distortion of multiple paths. Circularly polarized antennas are very suitable for phase array antennas of low-orbit satellites, radar phase array antennas and 5G base station phase array antennas, and applications of wireless communication broadband transmission are increasing in recent years. Therefore, miniaturization, wide band, high gain, broadband axis ratio, etc., of circular polarized antennas will be new challenges in the development of circular polarized antenna technology.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a structural schematic diagram of a circularly polarized antenna according to an embodiment of the present disclosure.

FIG. 2 is an embodiment of a combination structure diagram of an antenna unit and a feeding unit of the circularly polarized antenna shown in FIG. 1 according to the present disclosure.

FIG. 3 is a structural schematic diagram of an embodiment of a branch line coupler of the circularly polarized antenna in FIG. 1 according to the present disclosure.

FIG. 4 is a schematic diagram of an embodiment of a simulated field pattern and an actual measured pattern of the transmitting end of the circularly polarized antenna in a YZ plane according to the present disclosure.

FIG. 5 is a schematic diagram of an embodiment of a simulated pattern and an actual measured pattern of the transmitting end of the circularly polarized antenna in a XZ plane according to the present disclosure.

FIG. 6 is an embodiment of a simulated axial ratio curve diagram and an actual measured axial ratio curve diagram of the circular polarized antenna according to the present disclosure.

FIG. 7 is an embodiment of a simulated gain curve and an actual measured gain curve of the circular polarized antenna according to the present disclosure.

FIG. 8 is an embodiment of a simulated return loss curve and an actual measured return loss curve of a transmitting end TX of the circular polarized antenna according to the present disclosure.

FIG. 9 is a structure diagram of an embodiment of a direct connection between a feeding line group and a branch line coupler of the circularly polarized antenna according to the present disclosure.

FIG. 10 is a structural diagram of an embodiment of the connection between the feeding line group and the branch line coupler of the circularly polarized antenna through a matching microstrip line group according to the present disclosure.

FIG. 11 is a gain curve of the circularly polarized antenna when the feeding line group is directly connected to the branch line coupler and a gain curve when the feeding line is connected to the branch line coupler through the matching microstrip line group arranged on a different layer.

FIG. 12 is an axial ratio curve of the circularly polarized antenna when the feeding line group is directly connected to the branch line coupler, and an axial ratio curve when the feeding line group is connected to the branch line coupler through the matching microstrip line group arranged on a different layer.

FIG. 13 is an axial ratio curve of the circularly polarized antenna when the feeding line group is directly connected to the branch line coupler, and an axial ratio curve when the feeding line group is connected to the branch line coupler through the matching microstrip line group arranged on a different layer.

FIG. 14 is a structural diagram of an embodiment of a first antenna subunit of the circular polarized antenna according to the present disclosure.

FIG. 15 is a frequency curve of an embodiment of the first antenna subunit of the circularly polarized antenna at different chamfer sizes according to the present disclosure.

FIG. 16 is a structural diagram of an embodiment of a parasitic element of the circularly polarized antenna according to the present disclosure.

FIG. 17 is a frequency curve of the circularly polarized antenna when metal strips of the parasitic element with different widths according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

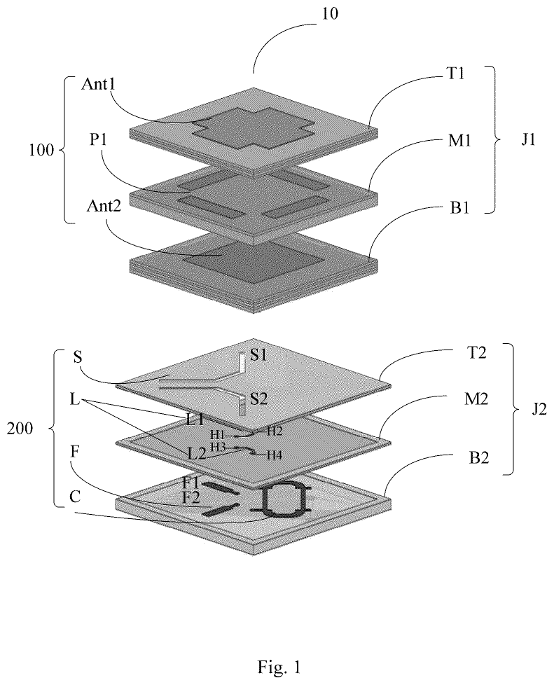

Referring to FIG. 1, FIG. 1 is a structural schematic diagram of a circularly polarized antenna according to an embodiment of the present disclosure. In the embodiment, a circularly polarized antenna 10 is mainly used in communication systems, such as low orbit satellite communication systems and radar communication systems. The circularly polarized antenna 10 operates in the Ku frequency band.

As shown in FIG. 1, the circularly polarized antenna 10 includes an antenna unit 100 and a feeding unit 200. The antenna unit 100 and the feeding unit 200 are stacked up and down. The antenna unit 100 is arranged on a first substrate J1. The first substrate J1 includes a top layer T1, a middle layer M1, and a bottom layer B1. The antenna unit 100 includes a first antenna subunit Ant1, a parasitic element P1, and a second antenna subunit Ant2. The first antenna subunit Ant1 includes a metal patch in a cross shape, and the first antenna subunit is arranged on the top layer T1 of the first substrate J1. The parasitic element P1 includes four metal strips forming a square with four unconnected sides, and the parasitic element P1 is arranged on the middle layer M1 of the first substrate J1. The second antenna subunit Ant2 includes a square metal patch, and the second antenna Ant2 is arranged on the bottom layer B1 of the first substrate J1.

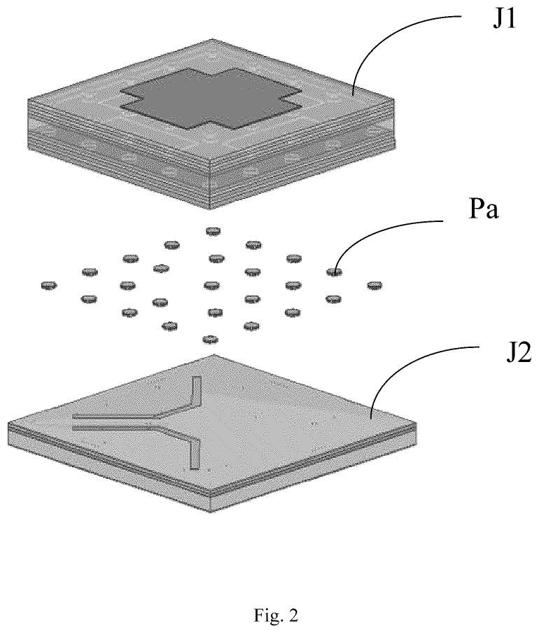

The feeding unit 200 is arranged on the second substrate J2, and the second substrate J2 includes a top layer T2, an intermediate layer M2, and a bottom layer B2. In the embodiment, the first substrate J1 is soldered onto the second substrate J2. Combining with FIG. 2, FIG. 2 is a combination structure diagram of the antenna unit and the feeding unit of the circularly polarized antenna according to an embodiment of the present disclosure. As shown in the FIG. 2, the bottom layer B1 of the first substrate J1 and the top layer T2 of the second substrate J2 are soldered by BGA pad Pa, so that the circularly polarized antenna 10 can reset the antenna unit 100, and the antenna unit 100 can be replaced according to application needs.

The feeding unit 200 includes a coupling slot group S, a matching microstrip line group L, a feeding line group F, and a branch line coupler C. The coupling slot group S is arranged on the top layer T2 of the second substrate J2, and the top layer of the second substrate is a grounded metal layer. The matching microstrip line group L is arranged on the middle layer M2 of the second substrate J2. The feeding line group F is arranged on the bottom layer B2 of the second substrate J2, and the branch line coupler C is arranged on the bottom layer B2 of the second substrate J2. The matching microstrip line group L is electrically connected between the feeding line F and the branch line coupler C through a hole group.

In the embodiment, the coupling slot group S can be used to couple signals received by the antenna unit 100 and further used to couple signals transmitted by the feeding unit 200. The coupling slot group S includes a first slot S1 and a second slot S2. A shape of combination of the first slot S1 and the second slot S2 is [symbol] -shaped.

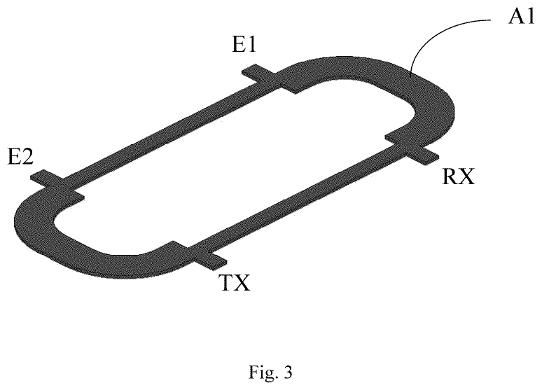

The branch line coupler C includes a first microstrip line A1, a receiving end RX, a transmitting end TX, a first feeding end E1, and a second feeding end E2. Combining with FIG. 3, FIG. 3 is a structural schematic diagram of the branch line coupler C of the circularly polarized antenna according to an embodiment of the present disclosure. The first microstrip line A1 is in a closed loop shape. The receiving end RX is connected to a side of the first microstrip line A1, the transmitting end TX is connected to the side of the first microstrip line A1 where the receiving end RX is connected. The first feeding end E1 is connected to connected to another side of the first microstrip line A1, and the another side of the microstrip line A is opposite the side of the first microstrip line A1 where the receiving end RX and the transmitting end TX are connected. The second feeding end E2 is connected to the side of the first microstrip line A1 where the first feeding end is connected.

In the embodiment, the feeding line group F includes a first feeding line F1 and a second feeding line F2. A shape of combination of the first feeding line F1 and the second feeding line F2 is a [symbol] -shaped. Taking transmission signals as an example, the transmission signals are coupled to the first slot S1 and the second slot S2 by the first feeding line F1 and the second feeding line F2 respectively, which can increase the isolation between the first feeding line F1 and the second feeding line F2. The first slot S1 and the second slot S2 share the grounded metal layer, shielding the antenna pattern from the interference of radiation from the feeding unit 200.

The matching microstrip line group L includes a first matching microstrip line L1 and a second matching microstrip line L2. A shape of combination of the first matching microstrip line L1 and the second matching microstrip line L2 is [symbol] -shaped. The first matching microstrip line L1 is electrically connected between the first feeding line F1 and the first feeding end E1 of the branch line coupler C through the first hole H1 and the second hole H2, respectively. The second matching microstrip line L2 is electrically connected between the second feeding line F2 and the second feeding end E2 of the branch line coupler C through the third hole H3 and the fourth hole H4, respectively.

In the embodiment, the feeding line group F can excite two polarization direction patterns through dual feeding. The first feeding line F1 is electrically connected to the first feeding terminal E1 to excite the horizontally-polarized pattern, and the second feeding line F2 is electrically connected to the second feeding terminal E2 to excite the vertically-polarized pattern. Taking the transmitter TX as an example, when signals enter the first microstrip line A1 from the transmitter TX, a first signal with a phase of 90 degrees is generated at the second input terminal E2 and a second signal with a phase of 180 degrees is generated at the first input terminal E1. The phase difference between the first signal and the second signal is 90 degrees, so that the phase condition of circular polarization is achieved. After passing through the matching microstrip line group L, the first signal and the second signal enter the feeding line group F to excite two patterns with different polarization directions. The first feeding line F1 excites the horizontally-polarized pattern, and the second feeding line F2 excites the vertically-polarized pattern. That is, the polarized pattern excited by the first feeding line F1 is perpendicular to the polarized pattern excited by the second feeding line F2. Then, the first signal and the second signal are coupled to the first slot S1 and the second slot S2, and then the first signal and the second signal are sequentially coupled to the second antenna subunit Ant2, parasitic element P1, and first antenna subunit Ant1, and finally radiated out to form a circularly polarized radiation pattern. The working principle of the receiving end RX for receiving signals is similar to that of the transmitting end TX for transmitting signals. Circularly polarized signals are received by the antenna unit 100, then the circularly polarized signals are coupled to the feeding unit 200, and finally the circularly polarized signals are received by the receiving end RX of the coupler C. In the embodiment, the transmitting end TX and receiving end RX of branch line coupler C do not work simultaneously, and the branch line coupler C can only transmit signal or receive signal at the same time. The left-handed circularly polarized pattern and the right-handed circularly polarized pattern are obtained respectively by the transmitting end TX and receiving end RX of the branch line coupler C. When a signal is transmitted to the branch line coupler C from the transmitting end TX, the left-handed circularly polarized pattern is excited, and when a signal is transmitted to the branch line coupler C from the receiving end RX, the right-handed circularly polarized pattern is excited. That is, a polarization of the polarized pattern generated by the signal transmitted from the transmitting end TX to the branch line coupler C is opposite to a polarization of the polarized pattern generated by the signal transmitted from the receiving end RX to the branch line coupler C. To change the direction of the excited the left-handed circularly polarized pattern and the right-handed circularly polarized pattern, the transmitting end TX and receiving end RX of the branch line coupler C can be swapped. Therefore, no matter whether the antenna array of the satellite station is left-handed circularly polarized or right-handed circularly polarized, the circularly polarized antenna of the present disclosure can match and obtain the same polarization direction, which increases the flexibility of the antenna.

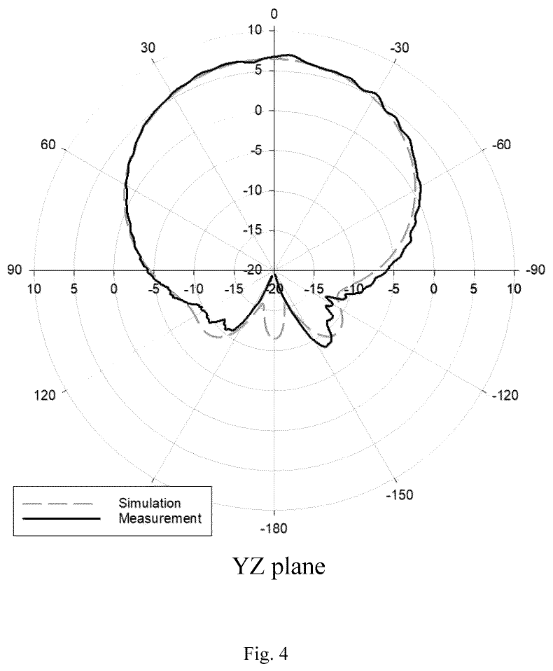

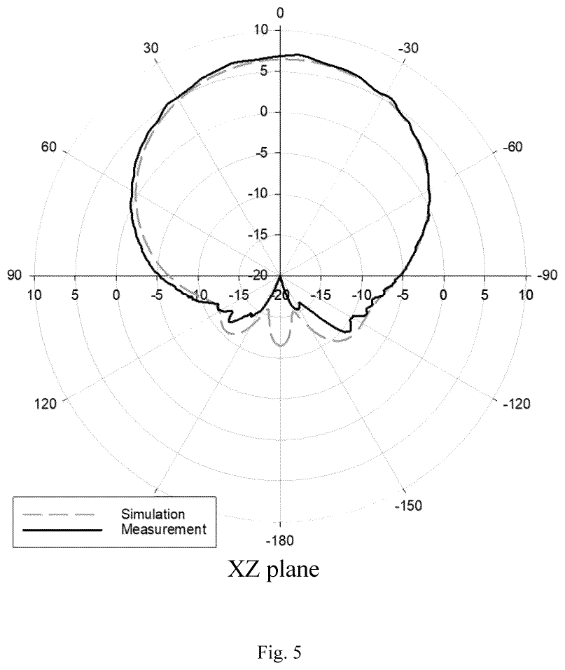

Referring to FIG. 4 and FIG. 5, FIG. 4 is a schematic diagram of a simulated field pattern and an actual measured pattern of the transmitting end of the circularly polarized antenna in a YZ plane according to an embodiment of the present disclosure. FIG. 5 is a schematic diagram of a simulated pattern and an actual measured pattern of the transmitting end of the circularly polarized antenna in a XZ plane according to an embodiment of the present disclosure. The pattern can be measured from the transmitting end TX and the receiving end RX. Since the transmitting end TX and the receiving end RX are symmetrical, the measured performance of the transmitting end TX and the receiving end RX is consistent. In the embodiment, taking the transmitting end TX as an example, as shown in FIG. 4 and FIG. 5, the gain and pattern obtained by measuring the transmitting end TX are in agreement with those obtained by simulation. The actual measured gain value is 7 dB at the first feeding end E1 on the XZ plane, and the actual measured gain value 6.9 dB at the second feeding end on the YZ plane, indicating that the circularly polarized antenna of the present disclosure has a good practical realization effect.

The radiation pattern of the circularly polarized antenna of the present disclosure is very suitable for satellite communication, mainly because the position of the antenna and the ground receiving station and orbiting satellite is constantly offset and changed. And if electromagnetic waves are reflected and refracted during propagation, resulting in resulting in polarization mismatch signal attenuation between the transmitting end and the receiving end, while the circularly polarized signal has the smallest attenuation in bad weather, and can penetrate the ionosphere, so the circularly polarized signal is not affected by the Faraday effect generated by the magnetic field of the north and south poles of the Earth and then affect the polarization mismatch signal weakening, to ensure the quality of communication.

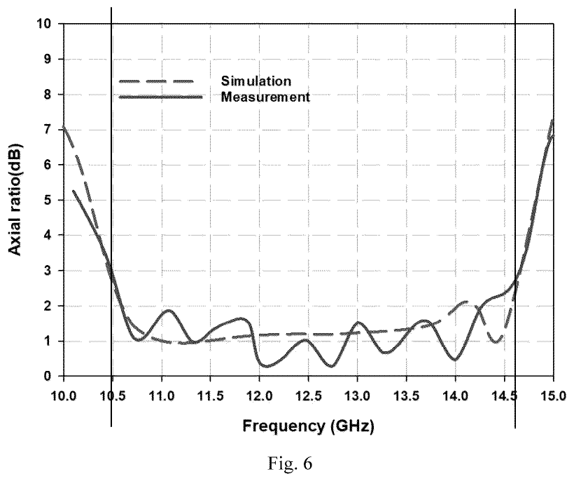

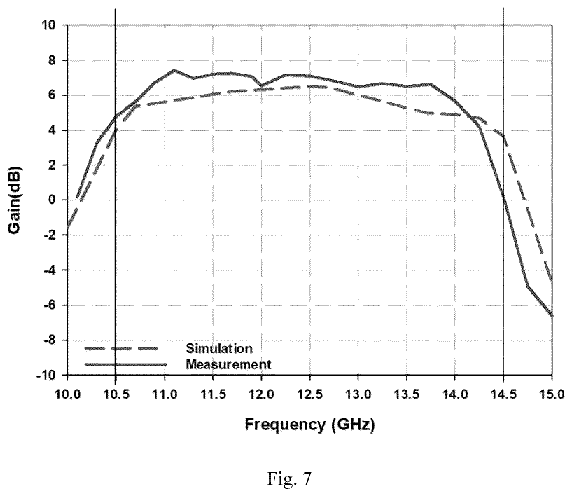

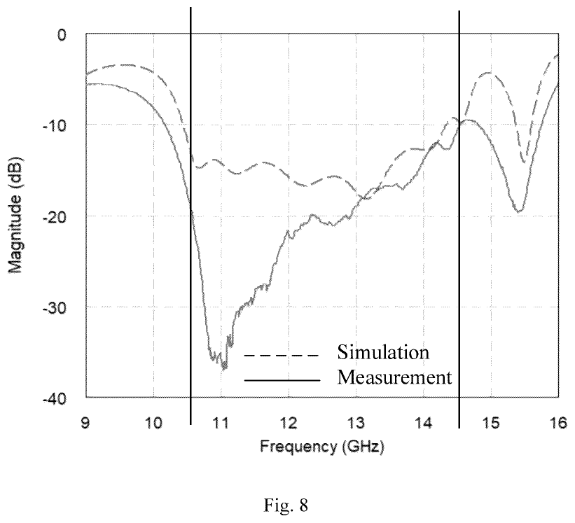

Referring to FIG. 6, FIG. 7, and FIG. 8. FIG. 6 is a simulated axial ratio curve diagram and an actual measured axial ratio curve diagram of the circular polarized antenna according to an embodiment of the present disclosure. FIG. 7 is a simulated gain curve and an actual measured gain curve of the circular polarized antenna according to an embodiment of the present disclosure. FIG. 8 is a simulated return loss curve and an actual measured return loss curve of the transmitting end TX of the circular polarized antenna according to an embodiment of the present disclosure. As shown in FIG. 6, the actual measured axial ratio bandwidth is consistent with the simulation. The frequency of axial ratio less than 3 dB is about 10.5 GHz˜14.6 GHz, and the axial ratio bandwidth is 4.1 GHz (32.8%). As shown in FIG. 7, the frequency of antenna simulation peak gain higher than 4 dB is 10.5 GHz˜14.5 GHz, the frequency of actual measured peak gain higher than 4 dB is 10.4 GHz˜14.3 GHz, and the gain bandwidth is 3.9 GHz (31.2 %). The bandwidth difference can be observed by observing the return loss curve. As shown in FIG. 8, the return loss is slightly shifted to the lower frequency of about 200 MHz in the actual measurement compared with the simulation, which is consistent with the peak gain measurement result.

In the embodiment, the matching microstrip line group L is arranged on different layer of the second substrate J2 relative to the first feeding line F1, the second feeding line F2, and the branch line coupler C. The substrate thickness is thickened through layer changing technology, thereby increasing the achievable impedance range to achieve impedance matching.

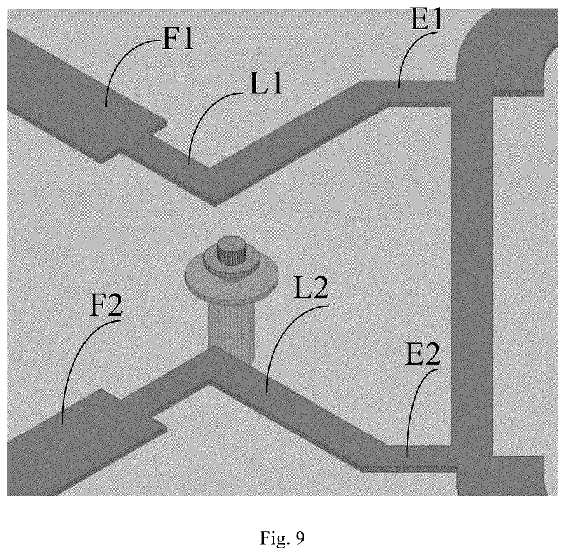

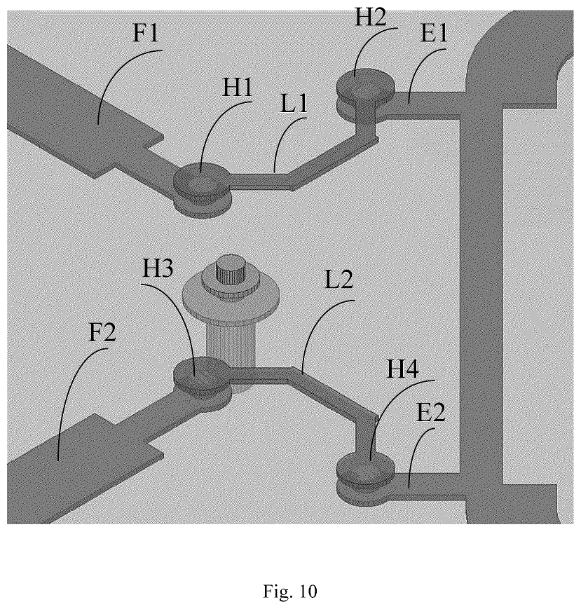

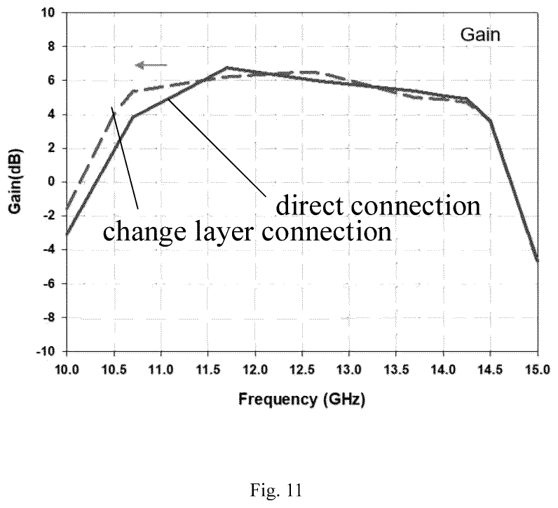

Referring to FIG. 9, FIG. 10 and FIG. 11, FIG. 9 is a structure diagram of the direct connection between the feeding line group F and the branch line coupler C of the circularly polarized antenna according to an embodiment of the present disclosure. FIG. 10 is a structural diagram of the connection between the feeding line group F and the branch line coupler C of the circularly polarized antenna through the matching microstrip line group L according to an embodiment of the present disclosure. FIG. 11 is a gain curve of the circularly polarized antenna when the feeding line group F is directly connected to the branch line coupler C and a gain curve when the feeding line F is connected to the branch line coupler C through the matching microstrip line group L arranged on different layer. As shown in FIG. 11, when the feeding line group F is directly connected to the branch line coupler C, the peak gain is greater than 4 dB (30.4%) in the bandwidth range from 10.7 GHz to 14.5 GHz. When the feeding line group F is connected to the branch line coupler C through the matching microstrip line group L arranged on different layer, the peak gain is greater than 4 dB in the bandwidth range from 10.5 GHz to 14.5 GHz (32%), and the gain bandwidth is increased by 200 MHz.

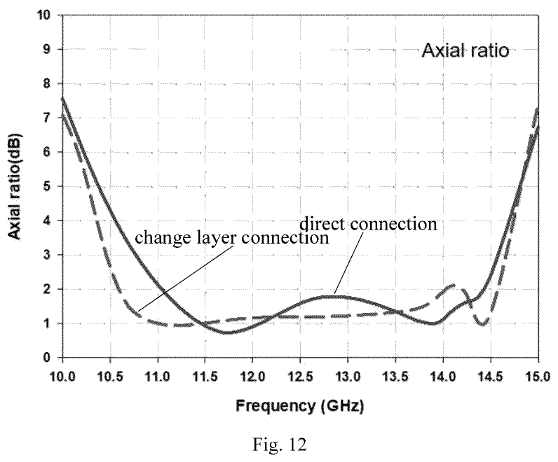

FIG. 12 is an axial ratio curve of the circularly polarized antenna when the feeding line group F is directly connected to the branch line coupler C, and an axial ratio curve when the feeding line group F is connected to the branch line coupler C through the matching microstrip line group L arranged on different layer. As shown in the figure, when the feeding line group F is directly connected to the branch line coupler C, the axial ratio is less than 3 dB in the bandwidth range from 10.8 GHz to 14.5 GHz (29.6 %). When the feeding line group F is connected to the branch line coupler C through the matching microstrip line group L arranged on different layer, the axial ratio is less than 3 dB in the bandwidth range from 10.5 GHz to 14.6 GHz (32.8 %), and the axial ratio bandwidth is increased by 400 MHz.

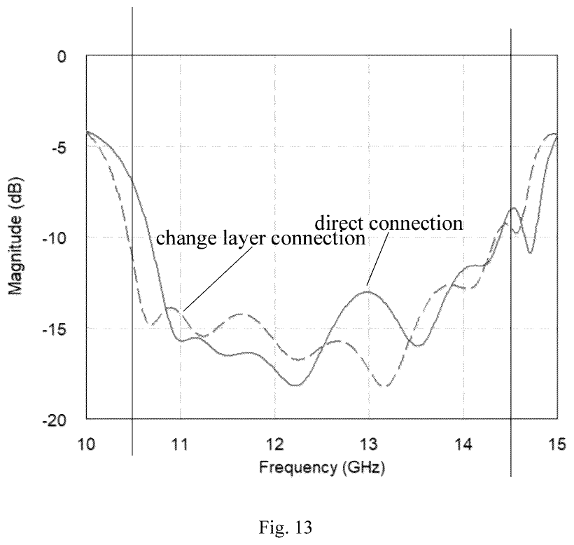

FIG. 13 is an axial ratio curve of the circularly polarized antenna when the feeding line group F is directly connected to the branch line coupler C, and an axial ratio curve when the feeding line group F is connected to the branch line coupler C through the matching microstrip line group L arranged on different layer. As shown in the FIG. 13, when the feeding line group F is directly connected to the branch line coupler C, the frequency of the return loss less than 10 dB is 10.7 GHz˜14.4 GHz (29.6%). When the feeding line group F is connected to the branch line coupler C through the matching microstrip line group L arranged on different layer, the frequency of return loss less than 10 dB is 10.5 GHz˜14.5 GHz (32%), and the return loss bandwidth is increased by 300 MHz.

When the feeding line group F is connected to the branch line coupler C through the matching microstrip line group L arranged on different layer, the return loss bandwidth, gain bandwidth and axial ratio bandwidth are increase by 300 MHz, 200 MHz and 400 MHz respectively, which optimizes the antenna performance.

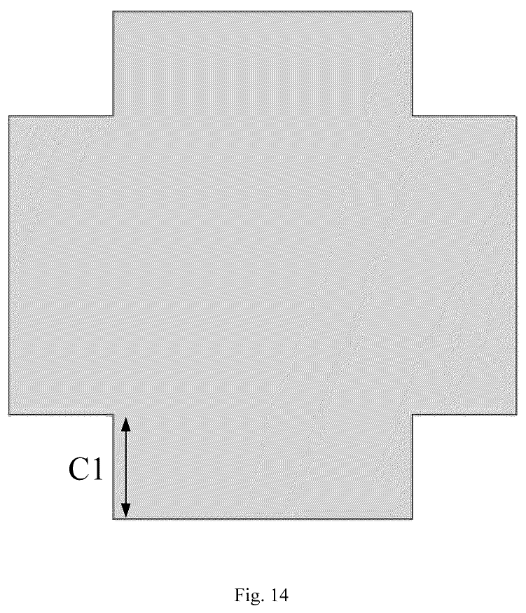

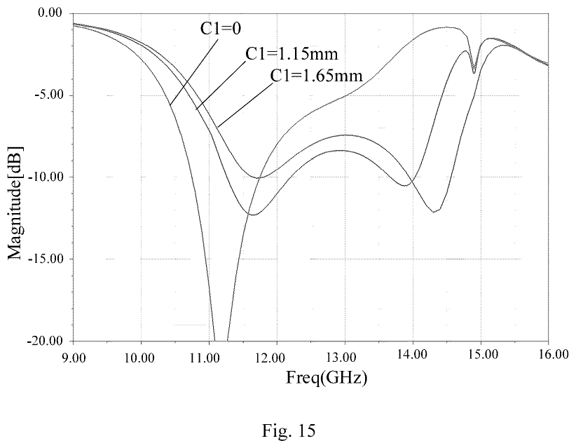

In the embodiment, a chamfer size C1 of the metal patch in the cross shape of the first antenna subunit is adjustable according to the operating bandwidth of the high frequency of the antenna unit 100 that has not been connected to the branch line coupler C. In combination with FIG. 14 and FIG. 15, FIG. 14 is a structural diagram of the first antenna subunit of the circular polarized antenna according to an embodiment of the present disclosure. FIG. 15 is a frequency curve of the first antenna subunit of the circularly polarized antenna at different chamfer sizes according to an embodiment of the present disclosure. As shown in the FIG. 15, when the chamfer size C1 is 0 mm, that is, without chamfer, no obvious high frequency point can be obtained, because without chamfer, the high-frequency impedance matching is poor. When the chamfer size C1 is 1.15 mm, the high frequency point is about 13.8 GHz. When the chamfer size C1 is 1.65 mm, the high frequency point is about 14.3 GHz. That is, within a certain range, the larger the chamfer size C1, the higher the high frequency point, and the wider the bandwidth range.

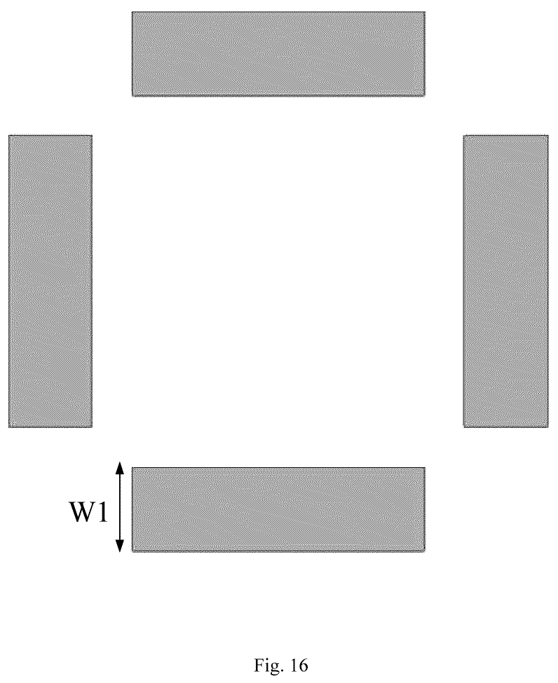

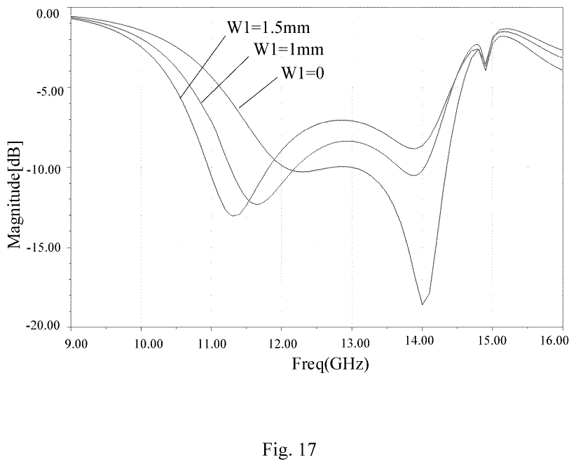

In the embodiment, a width of the four metal strips of the parasitic element P1 is adjustable according to the low-frequency bandwidth of the operating frequency band. In combination with FIG. 16 and FIG. 17, FIG. 16 is a structural diagram of the parasitic element of the circularly polarized antenna according to an embodiment of the present disclosure. FIG. 17 is a frequency curve of the circularly polarized antenna when the metal strips of the parasitic element with different widths according to an embodiment of the present disclosure. As shown in the FIG. 17, when the width W1 of the metal strips is 0, that is, when without the parasitic element P1, the low-frequency point is about 12.2 GHz. When the width W1 of the metal strips is 1 mm, the low-frequency point is about 11.8 GHz. When the width W1 of the metal strips is 1.5 mm, the low-frequency point is about 11.3 GHz. That is, within a certain range, the larger the width W1 of the metal strips, the lower the low-frequency point, and the wider the bandwidth range.

Compared with the prior art, the circular polarized antenna provided by the embodiment of the present disclosure includes an antenna unit and a feeding unit, and the antenna unit and the feeding unit are stacked up and down. The antenna part and the feeding part are set on different substrates, so that the circularly polarized antenna can reset the antenna unit, and the antenna unit can be replaced according to application needs. The matching microstrip line group L is arranged on different layer of the second substrate J2 relative to the first feeding line F1, the second feeding line F2, and the branch line coupler C. The substrate thickness is thickened through layer changing technology, thereby increasing the achievable impedance range to achieve impedance matching and increasing the gain bandwidth, the axial ratio bandwidth and the return loss bandwidth to optimize the antenna performance.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A circularly polarized antenna comprising an antenna unit and a feeding unit, the antenna unit and the feeding unit being stacked on top of each other, wherein
the antenna unit is arranged on a first substrate, and the antenna unit comprises:
a first antenna subunit comprising a metal patch in a cross shape, wherein the first antenna subunit is arranged on a top layer of the first substrate;
a parasitic element comprising four metal strips forming a square with four unconnected sides, wherein the parasitic element is arranged in a middle layer of the first substrate;
a second antenna subunit comprising a square metal patch, wherein the second antenna subunit is arranged on a bottom layer of the first substrate;
the feeding unit is arranged on a second substrate, and the feeding unit comprises:
a coupling slot group arranged on a top layer of the second substrate;
a matching microstrip line group arranged on a middle layer of the second substrate;
a feeding line group arranged on a bottom layer of the second substrate;
a branch line coupler arranged on the bottom layer of the second substrate, wherein the matching microstrip line group is electrically connected between the feeding line group and the branch line coupler through a hole group.

2. The circularly polarized antenna according to claim 1, wherein the first substrate is welded onto the second substrate.

3. The circularly polarized antenna according to claim 1, wherein a chamfer size of the metal patch in the cross shape of the first antenna subunit is adjustable according to a high-frequency bandwidth of an operating frequency band.

4. The circularly polarized antenna according to claim 1, wherein a width of the four metal strips of the parasitic element is adjustable according to a low-frequency bandwidth of an operating frequency band.

5. The circularly polarized antenna according to claim 1, wherein:
the coupling slot group is configured to couple signals received by the antenna unit and to couple signals transmitted by the feeding unit;
the coupling slot group comprises a first slot and a second slot, and a shape of a combination of the first slot and the second slot is [symbol] -shaped.

6. The circularly polarized antenna according to claim 1, wherein the branch line coupler comprises:
a first microstrip line in a closed loop shape;
a receiving end connected to a side of the first microstrip line;
a transmitting end connected to the side of the first microstrip line where the receiving end is connected;
a first feeding end, connected to another side of the first microstrip line, opposite to the side of the first microstrip line where the receiving end and the transmitting end are connected;
a second feeding end connected to the side of the first microstrip line where the first feeding end is connected.

7. The circularly polarized antenna according to claim 6, wherein:
the feeding line group comprises a first feeding line and a second feeding line, and a shape of a combination of the first feeding line and the second feeding line is [symbol] -shaped;
the matching microstrip line group comprises a first matching microstrip line and a second matching microstrip line, and a shape of a combination of the first matching microstrip line and the second matching microstrip line is [symbol] -shaped;
the first matching microstrip line is electrically connected between the first feeding line and the first feeding end of the branch line coupler through a first hole and a second hole, respectively;
the second matching microstrip line is electrically connected between the second feeding line and the second feeding end of the branch line coupler through a third hole and a fourth hole, respectively.

8. The circularly polarized antenna according to claim 7, wherein:
a polarized pattern excited by the first feeding line is perpendicular to a polarized pattern excited by the second feeding line.

9. The circularly polarized antenna according to claim 7, wherein:
a polarization of a polarized pattern generated by a signal transmitted from the transmitting end to the branch line coupler is opposite to a polarization of a polarized pattern generated by a signal transmitted from the receiving end to the branch line coupler.

10. A communication system comprising a circularly polarized antenna, wherein the circularly polarized antenna comprises an antenna unit and a feeding unit, and the antenna unit and the feeding unit are stacked up and down;
the antenna unit is arranged on a first substrate, and the antenna unit comprises:
a first antenna subunit comprising a metal patch in a cross shape, wherein the first antenna subunit is arranged on a top layer of the first substrate;
a parasitic element comprising four metal strips forming a square with four unconnected sides, wherein the parasitic element is arranged in a middle layer of the first substrate;
a second antenna subunit, wherein the second antenna subunit comprises a square metal patch, and the second antenna subunit is arranged on a bottom layer of the first substrate;
the feeding unit is arranged on a second substrate, and the feeding unit comprises:
a coupling slot group, arranged on a top layer of the second substrate;
a matching microstrip line group, arranged on a middle layer of the second substrate;
a feeding line group arranged on a bottom layer of the second substrate;
a branch line coupler arranged on the bottom layer of the second substrate, wherein the matching microstrip line group is electrically connected between the feeding line group and the branch line coupler through a hole group.

11. The communication system according to claim 10, wherein the first substrate is welded onto the second substrate.

12. The communication system according to claim 10, wherein a chamfer size of the metal patch in the cross shape of the first antenna subunit is adjustable according to a high-frequency bandwidth of an operating frequency band.

13. The communication system according to claim 10, wherein a width of the four metal strips of the parasitic element is adjustable according to a low-frequency bandwidth of an operating frequency band.

14. The communication system according to claim 10, wherein:
the coupling slot group is configured to couple signals received by the antenna unit and to couple signals transmitted by the feeding unit;
the coupling slot group comprises a first slot and a second slot, and a shape of a combination of the first slot and the second slot is [symbol] -shaped.

15. The communication system according to claim 10, wherein the branch line coupler comprises:
a first microstrip line, in a closed loop shape;
a receiving end connected to a side of the first microstrip line;
a transmitting end connected to the side of the first microstrip line wherein the receiving end is connected;
a first feeding end, connected to another side of the first microstrip line, opposite the side of the first microstrip line where the receiving end and the transmitting end are connected;
a second feeding end connected to the side of the first microstrip line where the first feeding end is connected.

16. The communication system according to claim 15, wherein:
the feeding line group comprises a first feeding line and a second feeding line, and a shape of a combination of the first feeding line and the second feeding line is [symbol] -shaped;
the matching microstrip line group comprises a first matching microstrip line and a second matching microstrip line, and a shape of a combination of the first matching microstrip line and the second matching microstrip line is [symbol] -shaped;
the first matching microstrip line is electrically connected between the first feeding line and the first feeding end of the branch line coupler through a first hole and a second hole, respectively;
the second matching microstrip line is electrically connected between the second feeding line and the second feeding end of the branch line coupler through a third hole and a fourth hole, respectively.

17. The communication system according to claim 16, wherein:
a polarized patterned excited by the first feeding line is perpendicular to a polarized patterned excited by the second feeding line.

18. The communication system according to claim 16, wherein:
a polarization of a polarized pattern generated by a signal transmitted from the transmitting end to the branch line coupler is opposite to a polarization of a polarized pattern generated by a signal transmitted from the receiving end to the branch line coupler.
